(19) United States
(12) Patent Application Publication
(10) Pub. No.: US 2016/0114422 A1
(43) Pub. Date: Apr. 28, 2016

(54) MISSING WELD PREVENTION SYSTEM FOR SPOT WELDERS

(71) Applicant: SUNG KAP KIM, Busan (KR)

(72) Inventor: SUNG KAP KIM, Busan (KR)

(21) Appl. No.: 14/361,291

(22) PCT Filed: Jul. 17, 2013
(86) PCT No.: PCT/KR2013/006407

§ 371 Date: May 28, 2014

(30) Foreign Application Priority Data
Jul. 2, 2013 (KR) 10-2013-0077414

(51) Int. Cl. B23K 11/36; H04N 7/18; H04N 5/232; B23K 31/00

(52) U.S. Cl. CPC B23K 11/36; B23K 31/003; H04N 7/181; H04N 5/23216

(57) ABSTRACT

A missing weld prevention system for spot welders is provided, which is a technology designed for spot welders to prevent missing welds by detecting any defects using a sensor while performing spot-welding before feeding work-pieces. Used for the spot welder is comprised of a lower welding tip and an upper welding tip moving up and down from the top of the lower welding tip, which welds the work-piece transferred through between the lower and upper welding tips by applying pressure and electric current, this invention features the primary photo sensor, the current sensor, the secondary photo sensor, and the control unit serving to detect missing spot welds.

### CROSS-REFERENCE TO RELATED APPLICATION

This application claims the benefit of Korean Patent Application No. 10-2013-0077414, filed on Jul. 2, 2013, in the Korean Intellectual Property Office, the disclosure of which is incorporated herein in its entirety by reference.

### BACKGROUND OF THE INVENTION

1. Field of the Invention

The present invention relates to a missing weld prevention system for spot welders, which is a technology designed for spot welders to prevent missing welds by detecting any defects using a sensor while performing spot-welding before feeding work-pieces.

2. Description of the Related Art

Generally, spot welding is a resistance welding process in which metal surfaces are held together under pressure exerted by the tips of upper and lower electrodes and joined by the heat obtained from resistance to electric current.

There is a disclosed conventional technology related to spot welding aimed at checking the state of welded work-pieces.

The conventional “Spot-Welding Check System” is comprised of a welding unit (3), which consists of a stationary holding jig (31), wherein the lower electrode of a spot welder (2) is electrically connected and a groove for mounting work-pieces is created, and a primary sensor (33) installed inside the aforementioned groove for mounting work-pieces, and which is designed to perform spot-welding after the primary sensor checks whether a work-piece has been inserted into the groove for mounting work-pieces of the stationary jig; a welding check unit (4) on one side of the said jig, which features a secondary sensor and a loading panel wherein a transfer path is created and, using the secondary sensor (42), checks whether the work-piece has been loaded after being spot-welded; a warning apparatus designed to alert the operator to whether the work-piece has been welded; a transfer unit consisting of a transfer frame mounted at the top of the aforementioned loading panel forming a double-layer structure and an operating cylinder connected to an end of the transfer frame to move the said frame back and forth, transferring the work-piece on the loading panel; a control unit, which operates the aforementioned warning apparatus when the foot pedal of the system starts working while the work-piece has not been sensed by the primary sensor, or when the work-piece starts being transferred to and loaded onto the loading panel by the transfer frame while the foot pedal is not working; and the warning apparatus of the system is comprised of a display panel and an alarm device.

However, while the conventional system is effective in that it allows the operator to check whether a work-piece has been welded or not, it has difficulty detecting whether a work-piece has been welded when certain changes are made to the welding conditions, such as more than two nuts are welded onto a plate.

### SUMMARY OF THE INVENTION

### Technical Problem

This invention aims to solve the aforementioned technical problem by providing a missing weld prevention system for spot welders, which ensures that work-pieces (e.g. plates and nuts) are precisely welded, counts and compares spot welds before and after the process to prevent the omission of any welds to be performed by the spot welder.

### Solution to Problem

To achieve the abovementioned purpose, the present invention, which is used for a spot welder featuring a lower welding tip and an upper welding tip moving up and down designed to weld the work-piece transferred between the lower and upper welding tips by applying pressure and electric current, is comprised of a primary photo sensor located on one side of the spot welder, which detects the state of the work-pieces fed to the spot welder; a current sensor electrically connected to the upper welding tip, which identifies electric current in the work-pieces transferred through between the upper and lower welding tips when the upper welding tip moves down; a secondary photo sensor located on the other side of the spot welder, which detects the state of the work-pieces discharged from the spot-welder; and a control unit wherein per-cycle counter settings for the primary photo sensor, current sensor, and secondary photo sensor have been pre-entered and a per-cycle counter outputs from the sequential operations of the primary photo sensor, current sensor, and second photo sensor have been entered so that outputs and settings are compared to control the operation of the upper welding tip.

The aforementioned work-pieces refer to plates and nuts.

The aforementioned control unit features a speaker through which per-cycle counter settings are entered for the primary photo sensor, current sensor, and secondary photo sensor, and the per-cycle counter outputs from the operations of the primary photo sensor, current sensor, and secondary photo sensor are respectively entered so that outputs and settings are compared and, provided that the outputs correspond to the settings, an alarm is set off to inform that the process is complete.

The aforementioned control unit features a display unit to display counter settings and outputs for the primary photo sensor, current sensor, and secondary photo sensor.

### Advantage of Invention

The present invention of the aforementioned structure is expected to have the following effects:

First, the system of the present invention checks the product feed counter using the primary photo sensor, displays the counter during welding using the current sensor, and checks whether the product has been welded by comparing the counter settings with the counter results of the welded product using the secondary photo sensor.

Furthermore, based on the compared counter results, the system helps to minimize errors by starting or stopping the operation of the spot welder.

### BRIEF DESCRIPTION OF THE DRAWINGS

FIG. 1 is a structural diagram of the conventional spot welding check system.

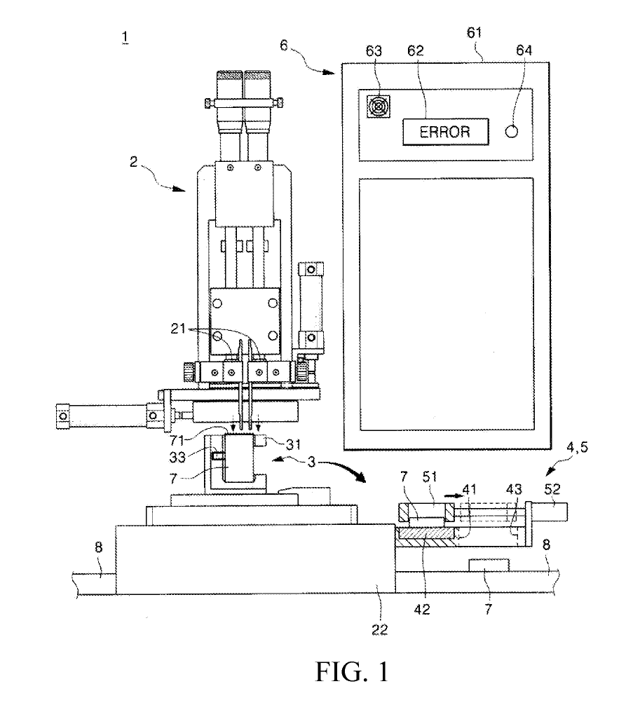

FIG. 2 is a structural diagram of the preferred embodiment of the missing weld prevention system for spot welders in this invention.

FIG. 3 is an exemplary diagram of the counter of the control unit.

### REFERENCE NUMERALS

100: Spot welder
120: Lower welding tip
140: Upper welding tip
200: Primary photo sensor
300: Current sensor
400: Secondary photo sensor
500: Control unit

### DETAILED DESCRIPTION OF THE PREFERRED EMBODIMENTS

The following provides a detailed description of a preferred embodiment of the present invention by referencing the drawings attached hereto.

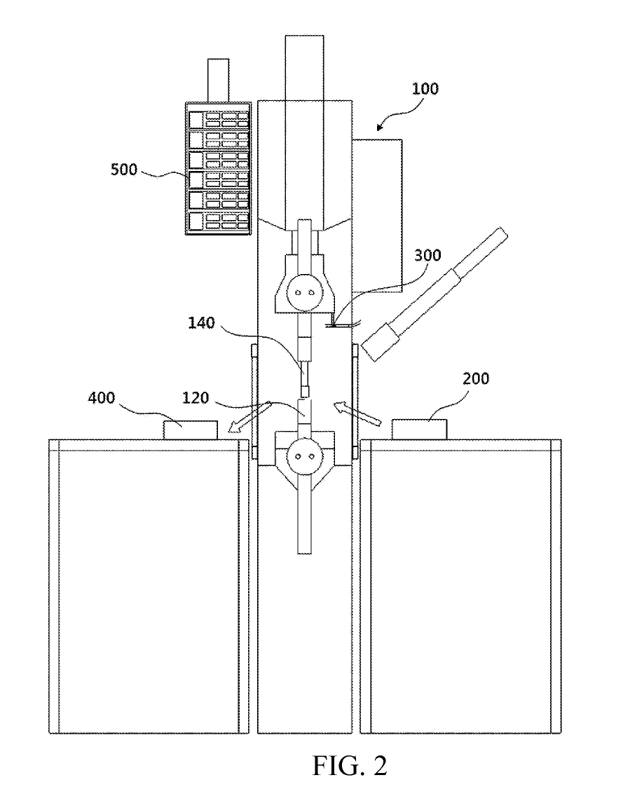

FIG. 2 is a structural diagram of the missing weld prevention system for spot welders according to the preferred embodiment of this invention.

According to FIG. 2, used for the spot welder 100 is comprised of a lower welding tip 120 and an upper welding tip moving up and down from the top of the lower welding tip 140, which welds the work-piece transferred through between the lower and upper welding tips by applying pressure and electric current, this invention features the primary photo sensor 200, the current sensor 300, the secondary photo sensor 400, and the control unit 500 serving to detect missing spot welds.

First of all, this embodiment of the present invention uses a plate and nuts as work-pieces, which are to be welded together and used as accessory components of an automobile.

The aforementioned primary photo sensor 200 located on one side of the aforementioned spot welder 100 detects the state of the work-pieces fed to the spot welder 100.

The primary photo sensor 200 identifies the aforementioned work-pieces by reflecting light onto them. The secondary photo sensor 400 also operates on the same principle.

The current sensor 300 is electrically connected to the aforementioned upper welding tip 140 and detects electric current in the work-pieces transferred through between the upper welding tip 140 and the lower welding tip 120 when the upper welding tip 140 moves down.

The secondary photo sensor 400 located on the other side of the spot welder 100 detects the state of the work-pieces discharged and transferred from the spot welder (100).

The aforementioned control unit 500 controls the operations of the primary photo sensor 200, the current sensor 300, and the secondary photo sensor 400, and the operation of the upper welding tip 140.

More specifically, the control unit 500 compares pre-entered per-cycle counter settings for the primary photo sensor 200, the current sensor 300, and the secondary photo sensor 400 with per-cycle counter outputs from the sequential operations of the primary photo sensor 200, the current sensor 300, and the secondary photo sensor 400 to control the operation of the upper welding tip 140.

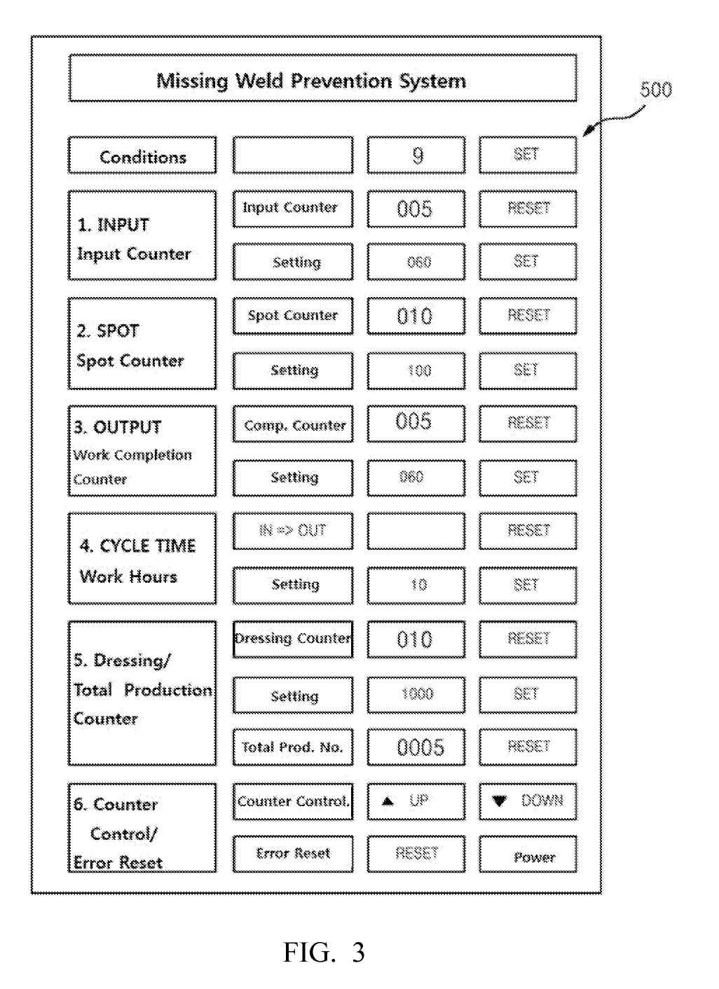

FIG. 3 is an exemplary diagram of the counter of the control unit.

According to FIG. 3, the unit can compare values entered (output from operation) in the counter for input products aligned with the primary photo sensor with pre-entered settings set values.

In other words, the control unit features a display unit to display counter settings and outputs for the primary photo sensor, the current sensor, and the secondary photo sensor, making it easier for the operator to identify and operate the system.

The system can also compare weld counts (output from operation) in the spot weld counter aligned with the current sensor with the settings (set values).

Furthermore, it can compare complete counts (output from operation) in the completed output counter aligned with the secondary photo sensor with the settings (set values).

Moreover, the system can check and set cycle times for sequential operations of the primary photo sensor, the current sensor, and the secondary photo sensor.

In this embodiment, the ratio of the input counter, the weld counter, and the output counter can be set to 1:2 (provided that two nuts are welded):1, and total quantity settings to 50 pieces, 100 pieces and 50 pieces to check whether the actual quantities are identical to the settings and to stop the system if the results do not conform to the settings in different areas.

The aforementioned control unit 500 features a speaker through which per-cycle counter settings are pre-entered for the primary photo sensor, current sensor, and secondary photo sensor, and per-cycle counter outputs from the operations of the primary photo sensor, current sensor, and secondary photo sensor are respectively entered so that outputs and settings are compared and, provided that the outputs correspond to the settings, an alarm is set off to inform that the process is complete.

This embodiment of the present invention is a representation of the basic technical concept of a missing weld prevention system for spot welders, and this invention may be modified in diverse ways by a person who has common knowledge in this field within the extent of the basic concept of the invention.

What is claimed is:

1. A missing weld prevention system for spot welders, wherein the spot welder features a lower welding tip and an upper welding tip moving up and down designed to weld work-pieces transferred between the lower and upper welding tips by applying pressure and electric current,
the missing weld prevention system being comprised of a primary photo sensor located on one side of the spot welder, which detects the state of the work-pieces fed to the spot welder;
a current sensor electrically connected to the upper welding tip, which identifies electric current in the work-pieces transferred through between the upper and lower welding tips when the upper welding tip moves down;
a secondary photo sensor located on the other side of the spot welder, which detects the state of the work-pieces discharged from the spot-welder; and
a control unit, wherein a per-cycle counter settings for a primary photo sensor, the current sensor, and the secondary photo sensor have been pre-entered and a per-cycle counter outputs from the sequential operations of the primary photo sensor, the current sensor, and the second photo sensor have been entered so that outputs and settings are compared to control the operation of the upper welding tip.

2. The missing weld prevention system for spot welders of claim 1, wherein the aforementioned work-pieces refer to a plate and nuts.

3. The missing weld prevention system for spot welders of claim 1, wherein the aforementioned control unit features a speaker through which the per-cycle counter settings are entered for the primary photo sensor, the current sensor, and the secondary photo sensor, and the per-cycle counter outputs from the operations of the primary photo sensor, the current sensor, and the secondary photo sensor are respectively entered so that outputs and settings are compared and, provided that the outputs correspond to the settings, an alarm is set off to inform that the process is complete.

4. The missing weld prevention system for spot welders of claim 1, wherein the aforementioned control unit features a display unit to display counter settings and outputs for the primary photo sensor, the current sensor, and the secondary photo sensor.
